(19) United States
(12) Patent Application Publication
(10) Pub. No.: US 2003/0046243 A1
(43) Pub. Date: Mar. 6, 2003

(54) Selective musical data base, system, and method

(76) Inventors: Dulcie Elizabeth Papsco, Forestville, CA (US); William George Papsco, Windsor, CA (US)

Correspondence Address: Risto A. Rinne, Jr., Suite E, 2173 East Francisco Blvd, San Rafael, CA, 94901, US

(21) Appl. No.: 09/943,014

(22) Filed: Aug. 29, 2001

(51) Int. Cl. G06F 17/60

(52) U.S. Cl. 705/52

(57) ABSTRACT

A system for the selection and subsequent receipt of audio signals over a common carrier such as the Internet or a telephone line by a user. The audio signals are a musical composition and may be received in real time and listened to while being received, or they may be compressed, as desired. Various methods whereby the user can subscribe to the system are disclosed. Apparatus disposed at the location of the user allows for the receipt and subsequent listening of the musical composition. A transceiver and figurine which are adapted to respectively transmit and receive the audio signal, are disclosed. The audio signal file is transmitted by the transceiver to the figurine, which receives it and which is also adapted to play the musical composition, such as to a child in a crib.

This application is related to pending patent application, Ser. No. 09/884,693 filed on Jun. 19, 2001 by inventor Dulcie Elizabeth Papsco, entitled “Selective Narrative Data Base, System, and Method”.

### BACKGROUND OF THE INVENTION

1. Field of the Invention

The present invention, in general relates to data bases and, more particularly, to a method of doing business that includes a data base and a menu that, upon payment of a fee, allows selection of a musical composition which is output in the form of audio signals.

The benefits of listening to a musical composition are almost infinite. People of all ages enjoy music and they enjoy listening to a variety of compositions.

Accumulating an assortment of musical compositions is expensive. Whether cassette tapes of compact discs (i.e., CDs) are the preferred medium, they are still expensive to purchase, especially when only one or two selections from an entire album are desired.

A method of listening to musical compositions that is less expensive is therefore desirable.

Also, music can be of great value to small children, especially when they are about ready to fall asleep. It can relax them and help them drift off to sleep. The problem again is to provide a diverse selection, and furthermore to present the music in a most appealing manner.

In addition to hearing music children greatly enjoy and even crave tactile stimulation. It is well known that copious amounts of touch are necessary for the proper development of a child. Touch is associated with being loved. Children love to be gently touched. That is why teddy bears and other toy figurines are so popular amongst children.

Stimulating the tactile sense, when combined with music, can deeply relax a child and bring about a sense of inner peace. Therefore, it is desirable for the child to receive positive tactile reinforcement, such as that which is derived from the child being able to hold a teddy bear or other type of a stuffed animal, especially so while the child listens to soothing music.

As a result of the “bonding” that occurs between a child and its “teddy bear” or other stuffed animal or figurine, the child develops a fondness, perhaps even a reliance upon the figurine for a time during the child's normal healthy development. Therefore, the figurine (i.e., teddy bear or other stuffed animal) with which the child has bonded is especially well suited to the task of comforting the child, as that is its principle purpose.

If the figurine were able to be used as a part of a system to play a musical composition to the child, then maximum benefit to the child would occur.

In addition to the above and other potential benefits of providing a system for providing musical composition audio signals, there is a business need to provide such a system that provides access over the telephone or Internet. A subscription service would potentially compensate service providers as well as the recording artists themselves.

Accordingly, there exists today a need for a selective musical data base, system, and method that helps to solve the aforementioned needs.

Clearly, such an apparatus, system, and method would be useful and desirable.

2. Description of Prior Art

Data bases are, in general, known. While the structural arrangements of the above known types of systems, at first appearance, may have similarities with the present invention, they differ in material respects. These differences, which will be described in more detail hereinafter, are essential for the effective use of the invention and which admit of the advantages that are not available with the prior devices.

### OBJECTS AND SUMMARY OF THE INVENTION

It is an object of the present invention to provide a selective musical data base, system, and method that is able to play a musical composition.

Still another object of the invention is to provide a selective musical composition data base, system, and method that allows a user to access a particular musical composition from amongst a plurality of musical compositions.

Still yet another object of the invention is to provide a selective musical data base, system, and method that includes a menu to facilitate the selection of a musical composition from amongst a plurality thereof.

Yet another important object of the invention is to provide a selective musical data base, system, and method that is adapted to download a musical composition to a user in real time.

Still yet another important object of the invention is to provide a selective musical data base, system, and method that is adapted to download a musical composition to a user in a compressed format (i.e., less than real time or in other than real time).

A first continuing object of the invention is to provide a selective musical data base, system, and method that provides access to a musical composition as part of a subscription service.

A second continuing object of the invention is to provide a selective musical data base, system, and method that provides access to a musical composition as part of a pay per access (i.e., per musical composition) service.

A third continuing object of the invention is to provide a selective musical data base, system, and method that provides access to a musical composition as part of a pay per minute type of service whereby a shorter musical composition is less expensive to listen to than would be a longer musical composition.

A fourth continuing object of the invention is to provide a selective musical data base, system, and method that provides access to a musical composition over the Internet.

A fifth continuing object of the invention is to provide a selective musical data base, system, and method that provides access to a musical composition over a telephone line.

A sixth continuing object of the invention is to provide a selective musical data base, system, and method that includes access to a server and a data base that includes a plurality of musical compositions stored in the data base, whereby a user can select and obtain one of the musical compositions that is stored in the data base.

A seventh continuing object of the invention is to provide a selective musical data base, system, and method that includes a transceiver (in a home) that is connected to either a computer, cable TV, or to a telephone and which is adapted to receive a musical composition audio signal from a server (i.e., a second computer) that is disposed at a remote location, and wherein the server is adapted to access a data base to obtain the audio signal and to download it to the transceiver, and wherein the transceiver is adapted to transmit the audio signal it has received to a remote device that preferably includes a figurine, such as a teddy bear, and wherein the remote device includes a receiver that is adapted to receive the audio signal and which also includes a speaker and means adapted for playing back the audio signal through the speaker, preferably via a stereo system.

An eight continuing object of the invention is to provide a selective musical data base, system, and method that provides access to a musical composition as part of a pay per minute type of a telephone service, such as by calling a “900” telephone number service whereby a shorter musical composition is less expensive to listen to than would be a longer musical composition.

Briefly, a selective musical data base, system, and method that is constructed in accordance with the principles of the present invention has a server (i.e., a computer) that is connected to a data base. The data base contains a plurality of musical compositions which are stored as files of audio signals. A user contacts the server over a telephone line or over the Internet and, if authorized, is provided access to the musical composition files in the data base. The user selects at least one of the musical composition files which is downloaded to the user either in real time or in a compressed format. The compressed format allows a transfer rate that is faster than the “real time” necessary to play the musical composition. The file preferably includes digital audio signals but it may also be an analog file of audio signals such as are suitable to drive a speaker. Accordingly, the file is adapted to be “played” to the user in real time. According to a particular preferred embodiment, a transceiver at the site of the user receives the audio signals that are downloaded from the server and transmits them to a figurine. The figurine contains a receiver and suitable circuitry and components to drive a speaker. The figurine is able to play the musical composition to a listener. The musical composition audio files may be downloaded to the user and listened to as they are received or stored for future listening.

### BRIEF DESCRIPTION OF THE DRAWINGS

FIG. 1 is a block diagrammatic view of a selective musical data base, system, and method for use over a telephone line.

FIG. 2 is a block diagrammatic view of a selective musical data base, system, and method for use over an Internet.

FIG. 3 is a flowchart of a selective musical data base, system, and method.

FIG. 4 is a block diagrammatic view of a selective musical data base, system, and method which shows components thereof that are disposed at the site of a user.

### DETAILED DESCRIPTION OF THE INVENTION

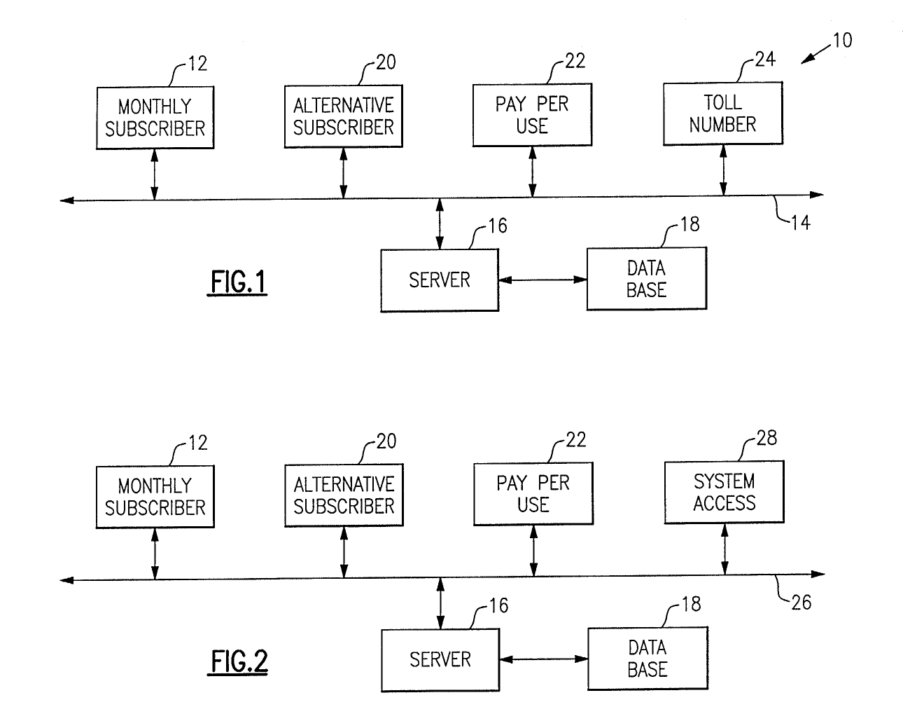

Referring to all of the drawings and in particular now to FIG. 1 is shown, a selective musical data base, system, and method, identified in general by the reference numeral 10.

A monthly subscriber 12 uses a telephone line 14 to make connection with a server 16. The server 16 provides the monthly subscriber 12 (or any other type of a subscriber) with a selection of various musical compositions that are contained in a data base 18.

The monthly subscriber 12 pays for the right to access and obtain receipt of the musical compositions by paying a monthly subscription amount (i.e., a fee) to a company (not shown) that supplies and/or maintains the server 16 and the data base 18.

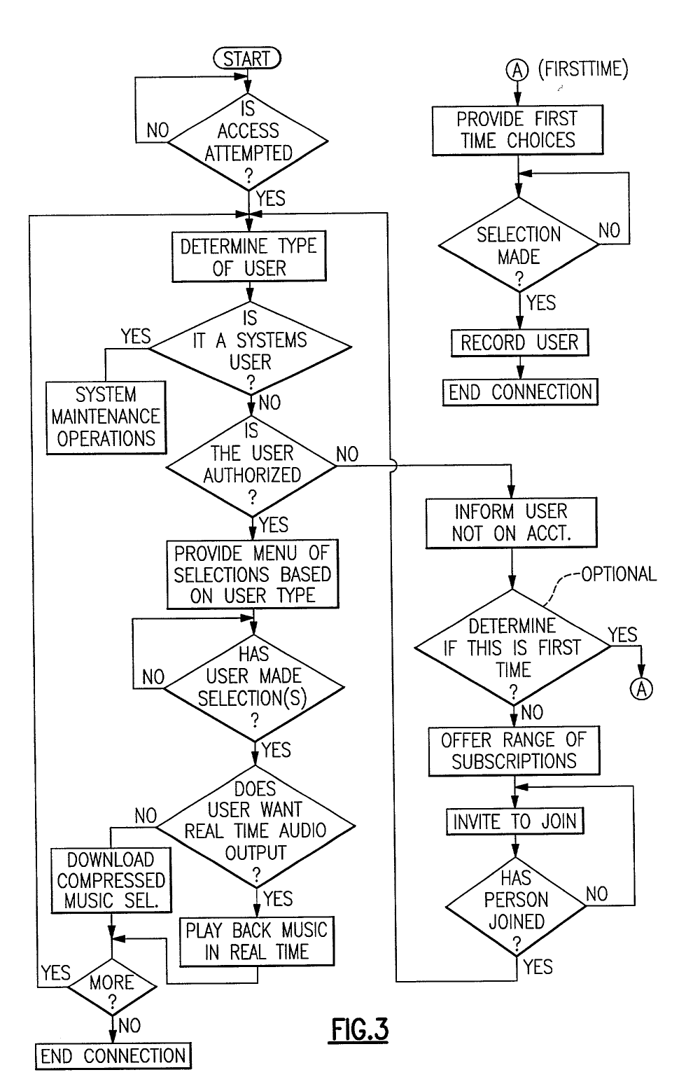

Referring now also to the flowchart of FIG. 3 is shown a possible logical structuring of the software of the server 16 in providing the monthly subscriber 12 (or other subscriber) with access to the system 10. This is discussed in greater detail hereinafter.

For now, let us assume that the monthly subscriber 12 has selected from a menu of choices that were presented, a particular musical composition to listen to. That musical composition is then played (i.e., transmitted) over the telephone line 14 in real time and the monthly subscriber 12 is able to listen to it over the telephone as it is being transmitted. Alternative methods of transmitting and of listening to the musical composition are discussed hereinafter.

An alternative type of a subscriber 20 is also provided with similar access to the system 10. The alternative subscriber 20 may pay on a yearly basis or any desired and agreed upon interval.

A pay per use subscriber 22 pays for each musical composition selection. The pay per use subscriber 22 may set up an account or simply pay for each connection made with the server 16 or prior to receipt of a transmission from the server 16. Payment can be made by charging each use against the account or, for example, with a credit card.

A toll number subscriber 24 may be provided with access to the server 16 by using (i.e., dialing) a telephone number that they are then billed at a particular rate per minute of access time. Sometimes, such telephone numbers are referred to as “900” types of telephone numbers. The toll number subscriber 24 pays a predetermined rate per minute for access time to the system 10. This is different than the pay per use subscriber 22 who pays only for the selections heard, which may be at a flat rate per selection or also proportional to the length. However, the pay per use subscriber 22 is not accruing additional cost merely for looking at a menu of musical composition selections that are available, whereas the toll number subscriber 24 is paying by the minute of time he is connected to the system 10, regardless of how that time is utilized.

Accordingly, listening in real time to a short musical composition will cost the toll number subscriber 24 less than it would to listen to a longer type of a musical composition.

Obviously, each of the various types of users 12, 20, 22, 24 uses their unique telephone number to connect with the server 16 thereby ensuring privacy and the receipt of the musical composition by the intended recipient (i.e., user).

Referring now to FIG. 2, the selective musical composition data base, system, and method 10 is shown substantially the same as in FIG. 1, except that access is provided over the Internet 26 and the toll number 24 is eliminated. While this type of a connection usually also includes a telephone or DSL type of a connection, the Internet 26 differs in that it allows generally for more rapid transfer of data and for the transfer of digital, rather than analog data.

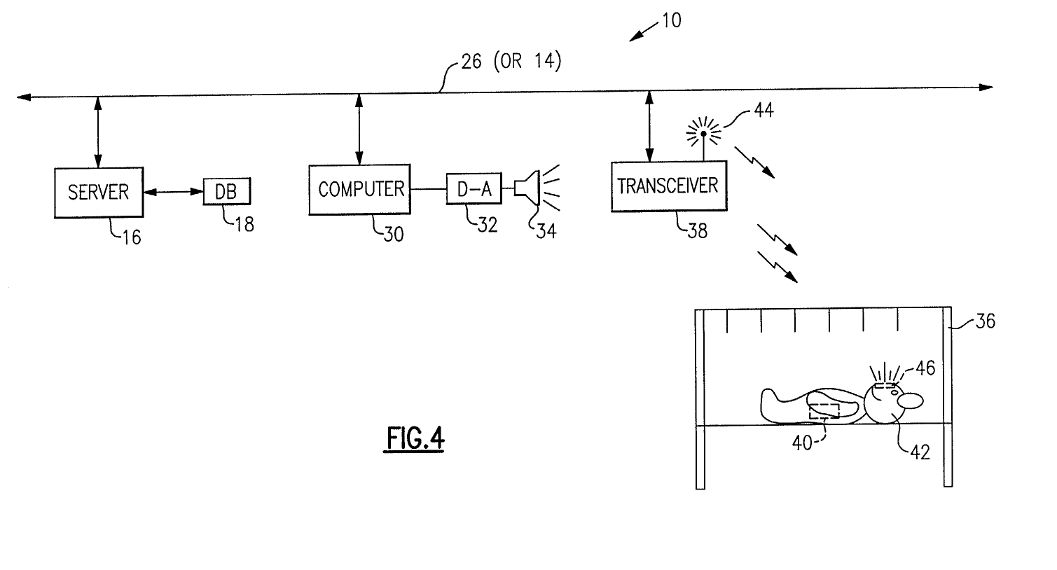

As is well known in the computer and the Internet 26 arts, each user 12, 20, 22, 24 would have a computer (see reference numeral 30, FIG. 4) that served as the interface between the user and the Internet 26 and which was adapted to make a data linkage connection with the server 16.

It is to be understood that the data base 18 includes a plurality of musical compositions that are each stored as separate files of audio signals. The audio signals may be either of an analog or a digital format. The system 10 allows the user 12, 20, 22, 24 to select which musical composition or which musical compositions are to be downloaded (i.e., received by the user 12, 20, 22, 24).

The transfer of the musical compositions from the data base 18 to the user may be either in real time or it may be of a compressed format (such as are known in the transmission arts) so as to take less time than is required to actually listen to the musical composition. The musical composition, once received, may be stored in the user's computer 30 (or other equipment, as is described in greater detail hereinafter) in either a digital or an analog format and listened to later, when desired. If desired, once stored, it may be listened to repeatedly.

An authorized system access 28 person who, by use of a special access protocol and security code, is able to gain access to the server 16 and to the data base 18 so as to make updates or changes thereto. For example, newly authorized monthly subscribers 12 may be added to the server 16 (or deleted therefrom) or new musical compositions may be added to the data base 18 or old, unpopular ones deleted. The special access protocol necessary to accomplish this for the authorized system access 28 person is well known in the computer arts and there are many such options available to choose from.

It is similarly possible to update the server 16 and the data base 18 over the telephone line 14 or it can be done in person or, if desired, the server 16 can be provided with the Internet 26 connection (for making upgrades or to service the system 10). Service of the system 10 can then occur over the Internet 26 simultaneous with the ability to provide musical composition service directly over the telephone line 14.

Referring again to FIG. 3, access either over the telephone line 14 or over the Internet 26 begins first by noting an attempt to gain access with the system 10. The next step is to then determine which type of a user (i.e., monthly 12, alternative 20, pay per use 22, toll number 24, or system access 28) is attempting to make the contact.

The flowchart does not provide operation for the authorized system access 28 person, as this protocol is determined by those who implement the software. However, software for the server 16 can be developed by those having ordinary skill in the art to provide whatever administrative and operational capabilities are required.

After determining which type of a user it is that is making contact, verification that the user is indeed authorized (i.e., is a currently paid monthly subscriber 12 or alternative subscriber 20 or has paid for the pay per use 22 attempt, or is calling over the toll number 24) is accomplished after which the user is provided with a menu of musical composition choices that are available. If desired, the pay per use 22 subscriber may be provided with a menu and not asked to pay until after having made selection of at least one musical composition to listen to.

The system waits for the user to make the selection or selections and then it determines how the musical composition is to be delivered, either as a real time analog file of audio signals that are transmitted in real time over the telephone line 14 or as a digitally compressed file of analog signals that are transmitted rapidly over the Internet 26. Once proper determination is made (which may require input from the user) the musical composition file is then sent to the user. If the user wants to view, make, or receive yet further selections, the process is repeated until the user desires to end the connection with the server 16.

There are also many options available which are briefly discussed, some of which are shown in the flowchart. For example, if the user is not authorized, the user may be provided with an opportunity to open and pay for an account and then be granted access. If the user is attempting to make contact with the system 10 for the first time, a special promotion, such as a free initial trial listening of one musical composition may be offered to the first time user. A recordation is then made that includes identification of the first time user so as to prevent any future attempts at obtaining free access to the system 10. Clearly, there is a vast opportunity and many variations in how the system 10 is configured and promoted are certainly possible.

Referring now to FIG. 4, a more detailed view of portions of the selective musical composition data base, system, and method 10 that are disposed at the site of the user 12, 20, 22 (or 24 if the telephone line 14, shown in parentheses, is used) are shown. The computer 30 is shown which is adapted to receive the musical composition in digital format over the Internet 26. The computer 30 includes components parts, either internal or externally disposed, that include a digital to analog converter 32 which is adapted to decompress the digital file of the musical composition (if necessary) and to convert it into a purely analog type of a signal that is suitable for driving a speaker 34. The analog signal may have to be amplified for proper listening. These technologies are well known to those in the computer and audio arts.

A preferred option for infants and children (not shown) that, for example, may be residing in a crib 36 includes the use of a transceiver 38 proximate a common carrier (either the telephone line 14 or the Internet 26). A receiver 40 (shown in dashed lines) is preferably contained within a figurine 42. The preferred type of a figurine 42 may include a teddy bear, a doll, or some other likeness.

In use, the transceiver 38 is connected to either the Internet 26 or the telephone line 14 and it accordingly, acquires the audio file of the desired musical composition. Assuming, for example, that the musical composition is acquired in real time, it is simultaneously transmitted by the transceiver 38 as soon as the transceiver 38 receives it. The transceiver 38 may use any known type of a modality to transmit the audio file of the musical composition to the receiver 40. The use of either amplitude modulation (AM) or frequency modulation (FM) types of a radio frequency 44 are well known and preferred.

The audio file of the musical composition is received (i.e., acquired) by the receiver 40 that is disposed (preferably) in the figurine 42. The figurine 42 must be disposed sufficiently near to the transceiver 44 to acquire the audio file. The receiver 40 demodulates the radio frequency 44 signal, as is well known in the radio frequency and transmission arts. The receiver 40 includes the necessary electrical circuitry to perform the necessary amplification of the pure audio signal portion of the musical composition (i.e., that portion which remains after demodulation has occurred). The musical composition is then played to the child in the crib 36 through an internal speaker 46 that is included in the figurine 42.

Accordingly, the child perceives the figurine 42 as being adapted to play the musical composition to him or to her. This is far more intimate and reassuring than would be listening to a tape player or a CD player, for example. This calms the child, helps the child go to sleep, comforts and amuses the child, and strengthens the bond between the child and the figurine 42.

The transceiver 44 or computer 30 may store the musical composition in a preferred format for later or repeated use.

Accordingly, a method of conducting business whereby a way to profit by selling access to the musical compositions to the various subscribers 12, 20, 22, 24 is provided.

Similarly, recording artists can be compensated (perhaps receive a stipend for each transmission of any selection of an audio file contained in the data base 18 that they have created). They may also be compensated through the increased notoriety that they gain. For example, at the start of each musical composition, the necessary acknowledgment of the recording artist, the author, and any other desired credits may also be made.

The invention has been shown, described, and illustrated in substantial detail with reference to the presently preferred embodiment. It will be understood by those skilled in this art that other and further changes and modifications may be made without departing from the spirit and scope of the invention which is defined by the claims appended hereto.

What is claimed is:

1. A selective musical data base and system, comprising:
(a) means for providing access to a common carrier, said common carrier adapted to transmit a file of audio signals from a first location to a second location;
(b) a server connected to said common carrier at said first location;
(c) a data base connected to said server, said data base including said file of audio signals and wherein said file of audio signals is sufficient to encode a musical composition; and
(d) means for transmitting said file of audio signals through said common carrier to a user disposed at said second location.

2. The selective musical data base and system of claim 1 wherein said common carrier includes a telephone line.

3. The selective musical data base and system of claim 1 wherein said common carrier includes an Internet.

4. The selective musical data base and system of claim 1 wherein said data base includes a plurality of said files, each of said plurality of files including a compilation of audio signals sufficient to encode a different musical composition.

5. The selective musical data base and system of claim 4 wherein said plurality of files includes all of the musical compositions of an album.

6. The selective musical data base and system of claim 1 wherein said means for transmitting said file of audio signals through said common carrier to a user disposed at said second location includes means for providing said user with said file in real time.

7. The selective musical data base and system of claim 1 wherein said means for transmitting said file of audio signals through said common carrier to a user disposed at said second location includes means for providing said user with said file in a compressed format that requires less time than is required to listen to said musical composition.

8. The selective musical data base and system of claim 1 including means for subscribing wherein authorization to obtain access to said file is denied to said user until said user has complied with said means for subscribing.

9. The selective musical data base and system of claim 8 wherein said means for subscribing includes a monthly subscription.

10. The selective musical data base and system of claim 8 wherein said means for subscribing includes a subscription for a time interval that is other than monthly.

11. The selective musical data base and system of claim 8 wherein said means for subscribing includes paying for each access to said system.

12. The selective musical data base and system of claim 8 wherein said means for subscribing includes means for paying for the amount of time said access to said system is provided.

13. The selective musical data base and system of claim 12 wherein said means for paying includes providing access via a telephone number that includes a charge that is made for each unit of elapsed time and wherein the elapsed time accrues whenever said user is connected to said server.

14. The selective musical data base and system of claim 1 including means for receiving said file of audio signals at said second location.

15. The selective musical data base and system of claim 14 wherein said means for receiving includes a transceiver.

16. The selective musical data base and system of claim 15 wherein said transceiver is adapted to transmit said file of audio signals to a third location.

17. The selective musical data base and system of claim 16 wherein said third location includes means for receiving said transmitted file of audio signals from said transceiver and includes means for converting said transmitted file into a format adapted for listening to said musical composition.

18. The selective musical data base and system of claim 17 wherein said third location is disposed in a figurine.

19. The selective musical data base and system of claim 18 wherein said figurine includes a stuffed figurine.

20. A method of providing a selective musical data base and system, comprising the steps:
(a) providing access to a common carrier;
(b) providing a server connected to said common carrier;
(c) providing a data base that is connected to said server, said data base including a plurality of files of audio signals that are each sufficient to encode a musical composition;
(d) providing means for selecting a particular file of audio signals by a user from said plurality of files; and
(e) transmitting said particular file of audio signals to said user using said common carrier.
